(19) United States
(12) Patent Application Publication
(10) Pub. No.: US 2026/0313388 A1
(43) Pub. Date: Oct. 8, 2026

(54) METHOD FOR DETERMINING DATA TYPE AND DEVICE

(71) Applicant: BEIJING XIAOMI MOBILE SOFTWARE CO., LTD., Beijing (CN)

(72) Inventor: Qin MU, Beijing (CN)

(21) Appl. No.: 19/100,856

(22) PCT Filed: Aug. 5, 2022
(86) PCT No.: PCT/CN2022/110708

§ 371 Date: Feb. 3, 2025

(51) Int. Cl. H04W 24/02; H04L 41/16; H04W 8/22

(52) U.S. Cl. CPC H04W 24/02; H04L 41/16; H04W 8/22

(57) ABSTRACT

A method for determining a data type is performed by a terminal device among a plurality of devices which jointly participate in performing a model task. The method includes determining a data type to be used in case of performing the model task, in which, a data type determined by the terminal device is the same as data types determined by other device among the plurality of devices excluding the terminal device.

### CROSS-REFERENCE TO RELATED APPLICATION

This application is a U.S. national phase of International Application No. PCT/CN2022/110708, filed Aug. 5, 2022, the entire content of which is incorporated herein by reference.

### TECHNICAL FIELD

The disclosure relates to a field of wireless communication technology, in particular to a method, an apparatus, and a device for determining a data type and a storage medium.

### BACKGROUND

AI models are widely applied in a plurality of fields with the ongoing development of AI (artificial intelligence) technology. Network nodes generally perform a model task (such as an AI model training task and/or an AI model deployment reasoning task) before applying the AI model. In related arts, it may be necessary to use a plurality of different network nodes to jointly participate in completing the model task.

### SUMMARY

In a first aspect, embodiments of the present disclosure provide a method for determining a data type. A plurality of devices jointly participate in performing a model task, and the method is performed by a terminal device among the plurality of devices. The method includes:
determining a data type to be used in case of performing the model task, in which a data type determined by the terminal device is the same as data types determined by other device among the plurality of devices excluding the terminal device.

In a second aspect, embodiments of the present disclosure provide a method for determining a data type. The method is performed by a network device, and the network device and other devices jointly participate in performing a model task, The method includes:
determining a data type to be used in case of performing the model task by respective devices configured to perform the model task, in which, the data type to be used in case of performing the model task determined by the network device for each device is same.

In a third aspect, embodiments of the disclosure provide a terminal device. The terminal device includes: a processor and a memory having a computer program stored thereon. The processor is configured to:
determine a data type to be used in case of performing the model task, in which, a data type determined by the terminal device is the same as data types determined by other device among the plurality of devices excluding the terminal device.

### BRIEF DESCRIPTION OF THE DRAWINGS

The above and/or additional aspects and advantages of the present disclosure will become apparent and readily understood from the following description of embodiments in combination with the accompanying drawings, in which:

FIG. 1 is a structural diagram of a communication system provided by an embodiment of the disclosure.

FIG. 2 is a flowchart of a method, performed by a terminal device among a plurality of terminal devices, for determining a data type provided by an embodiment of the disclosure.

FIG. 3 is a flowchart of a method for determining a data type provided by yet another embodiment of the disclosure.

FIG. 4 is a flowchart of a method for determining a data type provided by still another embodiment of the disclosure.

FIG. 5 is a flowchart of a method for determining a data type provided by another embodiment of the disclosure.

FIG. 6a is a flowchart of a method for determining a data type provided by yet another embodiment of the disclosure.

FIG. 6b is a flowchart of a method for determining a data type provided by yet another embodiment of the disclosure.

FIG. 7 is a flowchart of a method for determining a data type provided by still another embodiment of the disclosure.

FIG. 8 is a flowchart of a method, performed by a network device, for determining a data type provided by an embodiment of the disclosure.

FIG. 9 is a flowchart of a method for determining a data type provided by another embodiment of the disclosure.

FIG. 10 is a flowchart of a method for determining a data type provided by yet another embodiment of the disclosure.

FIG. 11a is a flowchart of a method for determining a data type provided by yet another embodiment of the disclosure.

FIG. 11b is a flowchart of a method for determining a data type provided by yet another embodiment of the disclosure.

FIG. 12 is a structural diagram of a communication device provided by an embodiment of the disclosure.

FIG. 13 is a structural diagram of a communication device provided by another embodiment of the disclosure.

FIG. 14 is a block diagram of a user equipment provided by an embodiment of the disclosure.

FIG. 15 is a block diagram of a network side device provided by another embodiment of the disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with embodiments of the disclosure. Instead, they are merely examples of apparatuses and methods consistent with aspects related to the disclosure as recited in the appended claims.

The terms used in the disclosure are only for the purpose of describing specific embodiments, and are not intended to limit embodiments of the disclosure. The singular forms of “a” and “the” used in the disclosure are also intended to include plural forms, unless the context clearly indicates other meanings. It is understandable that the term “and/or” as used herein refers to and includes any or all possible combinations of one or more associated listed items.

It is understandable that although the terms “first”, “second”, and “third” may be used in embodiments of the disclosure to describe various types of information, the information should not be limited to these terms. These terms are only used to distinguish the same type of information from each other. For example, without departing from the scope of the disclosure, the first information may also be referred to as the second information, and similarly, the second information may also be referred to as the first information. Depending on the context, the terms “if” and “in case of” as used herein may be interpreted as “when”, “upon” or “in response to determining”.

Embodiments of the disclosure are described in detail below, examples of which are illustrated in the accompanying drawings, in which the same or similar reference numerals refer to the same or similar elements throughout. The embodiments described below with reference to the accompanying drawings are exemplary and are intended to be used to explain the disclosure, but should not be constructed as limiting the disclosure.

To facilitate understanding, the terms involved in the present disclosure are first introduced.

### 1. Artificial intelligence (AI)

AI is a new technical science that studies and develops theories, methods, technologies and application systems for simulating, extending and expanding human intelligence.

The network elements/functions involved in embodiments of the disclosure may be independent hardware devices or functions realized by computer codes in the hardware devices, which is not limited in the embodiment of the disclosure.

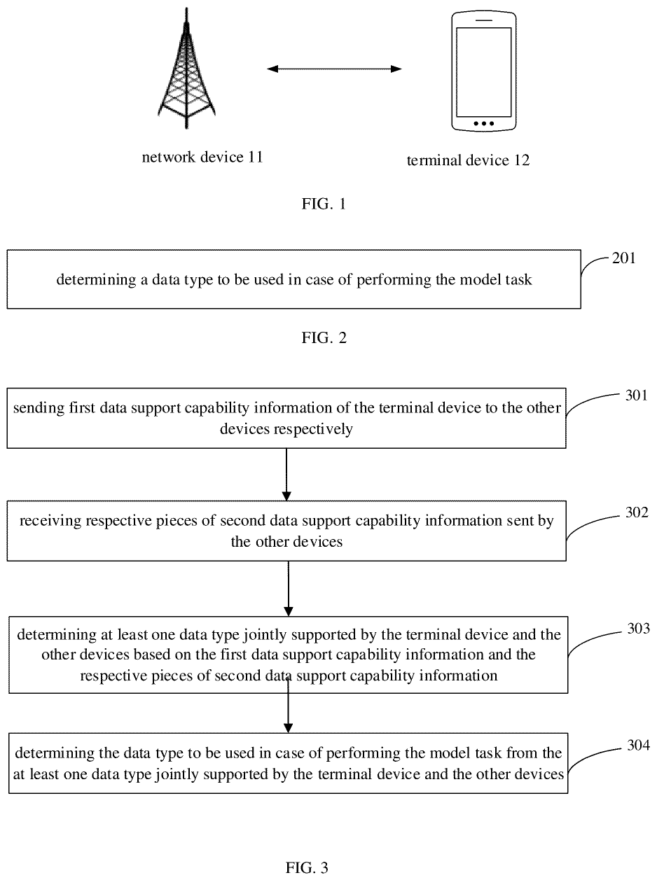

Please refer to FIG. 1, FIG. 1 is a structural diagram of a communication system provided by an embodiment of the disclosure. The communication system may include, but is not limited to, one network device and one terminal device. The number and the form of devices illustrated in FIG. 1 are only for examples and do not constitute a limitation on the embodiments of the disclosure. The communication system may include two or more network devices and two or more terminal devices in practical applications. The communication system as illustrated in FIG. 1 may include, for example, a network device 11 and a terminal device 12.

It is noteworthy that the technical solutions of the embodiments of the disclosure can be applied to various communication systems, such as, a long term evolution (LTE) system, a 5th generation (5G) mobile communication system, a 5G NR (new radio) system, or other future new mobile communication systems, etc.

The network device 11 in embodiments of the disclosure is an entity on a network side for transmitting or receiving signals. For example, the network device 11 may be an evolved NodeB (eNB), a transmission reception point (TRP), a next generation NodeB (gNB) in a NR system, a base station in other future mobile communication systems, or an access node in a wireless fidelity (WiFi) system. The specific technology and specific device form adopted by the network device are not limited in the embodiments of the disclosure. The network device according to embodiments of the disclosure may be composed of a central unit (CU) and distributed units (DUs). The CU may also be referred to as a control unit. The use of CU-DU structure allows to divide a protocol layer of the network device, such as a base station, such that some of the protocol layer functions are placed in the CU for centralized control, and some or all of the remaining protocol layer functions are distributed in the DUs, and the DUs are centrally controlled by the CU.

The terminal device 12 in embodiments of the disclosure is an entity on a user side for receiving or transmitting signals, such as a cellular phone. The terminal device may also be referred to as a terminal, a user equipment (UE), a mobile station (MS), a mobile terminal (MT), and the like. The terminal device can be a car with communication functions, a smart car, a mobile phone, a wearable device, a Pad, a computer with wireless transceiver functions, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The specific technology and specific device form adopted by the terminal device are not limited in embodiments of the present disclosure.

It is understandable that the communication system described in embodiments of the present disclosure is intended to clearly illustrate the technical solutions according to embodiments of the present disclosure, and does not constitute a limitation on the technical solutions according to embodiments of the present disclosure. It is understandable by those skilled in the art that as system architectures evolve and new business scenarios emerge, the technical solutions according to embodiments of the disclosure are also applicable to similar technical problems.

AI models are widely applied in a plurality fields with ongoing development of AI (artificial intelligent) technology. Network nodes generally perform a model task (such as an AI model training task and/or an AI model deployment reasoning task) before applying the AI model. In related arts, there may need a plurality of different network nodes to jointly participate in completing the model task.

However, in the related arts, different network nodes may support different data types. Based on this, in a case that the plurality of network nodes jointly participate in the model task, there may be a situation that different network nodes use different types of data types, which may reduce an accuracy of the plurality of network nodes in case of performing the model task (for example, a need for conversion between the data types of different network nodes may result in reduced accuracy of the AI model training or the AI model reasoning), and may further result in lower accuracy of the final AI model and reduce user experience of the AI models.

A method, an apparatus, and a device for determining a data type and a storage medium provided by embodiments of the present disclosure will be described in detail below with reference to the accompanying drawings.

FIG. 2 is a flowchart of a method for determining a data type provided by an embodiment of the disclosure. In the present disclosure, a plurality of devices jointly participate in performing a model task. The method is performed by a terminal device among the plurality of devices. As illustrated in FIG. 2, the method may include a following step.

At step 201, a data type to be used in case of performing the model task is determined.

In an embodiment of the present disclosure, the above model task may include a model training task and/or a model reasoning task. The above-mentioned “the plurality of devices jointly participate in performing the model task” can be understood as: the plurality of devices jointly perform one model task (such as the model training task or the model reasoning task). Each different device is configured to be responsible for at least a part of the model training task. The model task is implemented through interaction between respective devices.

The above data type may include at least one of an integer (int), a single float (i.e., a 16-bit float), and a double float (i.e., a 32-bit float).

In an embodiment of the present disclosure, the plurality of devices participating in performing the model task may or may not include a network device. In a case that the plurality of devices includes or do not include the network device, there may be, for the terminal device, a different method of determining the data type to be used in case of performing the model task.

Specifically, in an embodiment of the present disclosure, in a case that the plurality of devices includes the network device, each terminal device may report capability information related to its supported data type (i.e., first data support capability information or second data support capability information mentioned later) to the network device, so that the network device determines the data type for performing the model task based on the received capability information, and sends indication information of the determined data type to each terminal device, rendering that each terminal device may determine the data type to be used in case of performing the model task based on the indication information.

In another embodiment of the present disclosure, in a case that the plurality of devices do not include the network device (that is, the plurality of devices are all terminal devices), the respective devices may interact with each other in terms of capability information related to their supported data types, so that each device knows the data types supported by the other devices, then each device may independently determine the data type to be used in case of performing the model task based on the data types supported by the plurality of devices participating in performing the model task. The specific implementation method of the above content will be introduced in detail in subsequent embodiments.

In addition, it is noted that in an embodiment of the present disclosure, the data type determined by the terminal device by performing the above step 201 is the same as the data types determined by the other devices among the plurality of devices, which may ensure that the terminal device can use the same data type as the other devices to perform the model task, may further ensure unification of data types of performing the model task by the plurality of devices, and ensure an accuracy of performing the model task.

To sum up, in the method for determining the data type provided by an embodiment of the present disclosure, the terminal device determines the data type to be used in case of performing the model task, in which, the data type determined by the terminal device is the same as the data types determined by the other device among the plurality of devices excluding the terminal device. That is, in the present disclosure, the data type to be used in case of performing the model task determined by each of the plurality of devices that jointly participate in performing the model task is the same, so that the plurality of devices may perform the model task based on the same data type. There is no need to type-convert usage data of the plurality of devices during performing the model task, thus ensuring a performing accuracy of the model task, further ensuring an accuracy of an AI model obtained based on the model task, and improving user experience of the AI model.

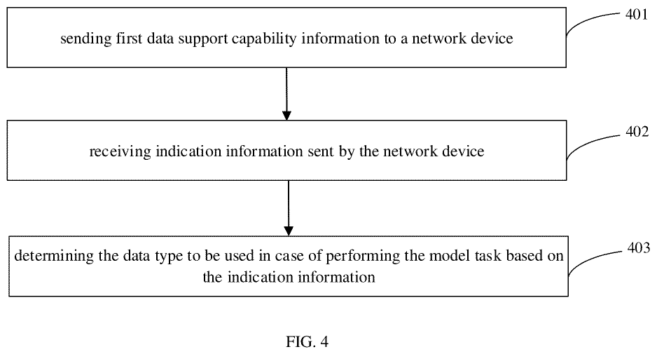

FIG. 3 is a flowchart of a method for determining a data type provided by an embodiment of the disclosure. The method is performed by a terminal device. A plurality of devices jointly participate in performing a model task, and the method is performed by a terminal device among the plurality of devices. As illustrated in FIG. 3, the method may include following steps.

At step 301, first data support capability information of the terminal device is sent to the other devices respectively.

In an embodiment of the present disclosure, the above first data support capability information indicates a data type supported by the terminal device. The data type supported by the terminal device may include at least one of an integer, a single float, and a double float.

It is noted that different data types may have different accuracies. However, it should be recognized that in a case that the terminal device supports a certain data type with a higher accuracy, it is also implicitly instructed that the terminal device supports a data type with lower accuracy than a certain data type. For example, assumed that the data type supported by the terminal device is double float, since an accuracy of the integer is smaller than an accuracy of the single float and smaller than an accuracy of double float, it is implicitly indicated that the terminal device also support the integer and the single float in a case that the data type supported by the terminal device is the double float.

In addition, in an embodiment of the present disclosure, the above first data support capability information may be sent by the terminal device to the other devices via a D2D (device to device) manner.

At step 302, respective pieces of second data support capability information sent by the other devices are received.

In an embodiment of the present disclosure, the respective pieces of second data support capability information indicate data types supported by the other devices. The data type supported by each of the other devices may be at least one of the integer, the single float, or the double float.

In an embodiment of the present disclosure, the respective pieces of second data support capability information may be sent by the other devices to the terminal device in a D2D manner.

As can be seen from steps 301-302, in an embodiment of the present disclosure, in a case that the plurality of devices participating in performing the model task do not include the network device, the plurality of devices may interact with each other in terms of their data support capability information, rendering that each device participating in the model task knows the data types supported by the other devices in addition to itself. Subsequently, each device may determine the final data type to be used in case of performing the model task based on both the data types supported by the other devices and the data type supported by itself (i.e., subsequent steps 303-304).

At step 303, at least one data type jointly supported by the terminal device and the other devices is determined based on the first data support capability information and the respective pieces of second data support capability information.

In an embodiment of the present disclosure, the data type jointly indicated by the first data support capability information and the second data support capability information may be determined as the data type jointly supported by the terminal device and the other devices.

For example, in an embodiment of the present disclosure, it is assumed that the first data support capability information of the terminal device indicates that the data types supported by the terminal device include the integer and the single float, and the second data support capability information of other device #1 indicates that the data types supported by the other device #1 include the integer, the single float, and the double float, it is determined that the data types supported by the terminal device and the other device #1 include the integer and the single float.

At step 304, the data type to be used in case of performing the model task is determined from the at least one data type jointly supported by the terminal device and the other devices.

In an embodiment of the present disclosure, the method of determining the data type to be used in case of performing the model task from the at least one data type jointly supported by the terminal device and the other devices may include at least one of following methods.

Method 1: a first data type with a maximum accuracy among the at least one data type jointly supported is determined as the data type to be used in case of performing the model task.

In an embodiment of the present disclosure, an accuracy of the data type is proportional to a count of bits corresponding to the data type. That is, a data type with more bits have a greater accuracy. For example, a count of bits of an integer is 8 bits, a count of bits of a single float is 32 bits, and a count of bits of a double float is 64 bits, then an accuracy relationship corresponding to the three data types is: double float [symbol] single float [symbol] integer.

Based on this, in an embodiment of the present disclosure, the above method of determining the first data type with the maximum accuracy among the at least one data type jointly supported as the data type to be used in case of performing the model task is: determining the first data type with the most bits among the data types jointly supported as the data type to be used in case of performing the model task For example, in an embodiment of the present disclosure, it is assumed that the data types jointly supported include the integer and the single float, the count of bits of the single float is greater than the count of bits of the integer, and the single float is data with the maximum accuracy among the data types jointly supported, at this case, the single float can be directly determined as the data type to be used in case of performing the model task.

Method 2: a second data type with less accurate than the first data type among the at least one data type jointly supported is determined as the data type to be used in case of performing the model task.

In an embodiment of the present disclosure, the data type with the maximum accuracy among the data types jointly supported may not be selected as the data type to be used in case of performing the model task. Instead, the data type with an accurate less than the maximum accurate may be selected as the data type to be used in case of performing the model task. This may ensure a performing accuracy of the model task and reduce performing costs.

For example, in an embodiment of the present disclosure, assumed that the data types jointly supported include the integer, the single float, and the double float, it may be determined that the data type with the maximum accuracy (i.e., the aforementioned first data type) is the double float. At this case, a data type with an accuracy less than the accuracy of the double float (such as the integer or the single float) from the data types jointly supported is determined as the data type to be used in case of performing the model task.

Method 3: the data type to be used in case of performing the model task from the at least one data type jointly supported is determined based on a desired resource overhead of the model task.

In an embodiment of the present disclosure, in response to a smaller desired resource overhead of the model task, a data type with fewer bits and a lower accuracy is selected, and in response to no limitation on the desired resource overhead of the model task, a data type with more bits and a higher accuracy is selected.

For example, in an embodiment of the present disclosure, assumed that the data types jointly supported include the integer, the single float, and the double float, at this case, in response to a smaller desired resource overhead of the model task, the integer type may be selected as the data type to be used in case of performing the model task, and in response to no limitation on the desired resource overhead of the model task, the double float may be selected as the data type to be used in case of performing the model task.

Method 4: the data type to be used in case of performing the model task is determined from the at least one data type jointly supported based on a service demand of the model task.

In an embodiment of the present disclosure, the service demand may be a latency demand of the model task. Based on this, the above method of determining the data type to be used in case of performing the model task from the at least one data type jointly supported based on the service demand of the model task may include, in response to a higher latency demand of the model task, selecting a data type with fewer bits and a lower accuracy, in response to a lower latency demand of the model task, selecting a data type with more bits and a higher accuracy.

For example, in an embodiment of the present disclosure, assumed that the data types jointly supported include the integer, the single float, and the double float, at this case, in response to the service demand of the model task having a high latency demand, the integer type is selected, and in response to the service demand of the model task having a low latency demand, a single float is selected.

In addition, it is noted that in an embodiment of the present disclosure, in a case that each terminal device among the plurality of devices independently determines the data type to be used from the data types jointly supported by performing the above steps 303-304, each terminal device may adopt the same method to determine the data type to be used from the data types jointly supported. For example, each terminal device may adopt the above method 3 to determine the data type to be used in case of performing the model task, or each terminal device may adopt the above method 1 to determine the data type to be used in case of performing the model task, thus ensuring that the data type determined by each terminal device is the same, ensuring the accuracy of performing the model task.

The method of the embodiment corresponding to FIG. 3 (i.e., step 301-step 304) may be applied to a scenario where “the plurality of devices participating in performing the model task do not include the network device (i.e., the plurality of devices participating in performing the model task are all terminal devices)”.

To sum up, in the method for determining the data type provided by an embodiment of the present disclosure, the terminal device determines the data type to be used in case of performing the model task, in which, the data type determined by the terminal device is the same as the data types determined by the other device among the plurality of devices excluding the terminal device. That is, in the present disclosure, the data type to be used in case of performing the model task determined by each of the plurality of devices that jointly participate in performing the model task is the same, so that the plurality of devices may perform the model task based on the same data type. There is no need to type-convert usage data of the plurality of devices during performing the model task, thus ensuring a performing accuracy of the model task, further ensuring an accuracy of an AI model obtained based on the model task, and improving user experience of the AI model.

FIG. 4 is a flowchart of a method for determining a data type provided by an embodiment of the disclosure. A plurality of devices jointly participate in performing a model task. The method is performed by a terminal device among the plurality of devices. As illustrated in FIG. 4, in response to the plurality of devices including a network device, the method may include following steps.

At step 401, first data support capability information is sent to the network device.

In an embodiment of the present disclosure, the first data support capability information indicates a data type supported by the terminal device.

It is noted that, in an embodiment of the present disclosure, in a case that the plurality of devices participating in performing the model task include the network device and the terminal device, each terminal device in the plurality of devices needs to send the first data support capability information to the network device.

At step 402, indication information sent by the network device is received.

In an embodiment of the present disclosure, the indication information indicates the data type to be used in case of performing the model task. The data type indicated by the indication information is specifically determined by the network device based on the first data support capability information sent by each terminal device.

In an embodiment of the present disclosure, the indication information received by each terminal device is the same, thus ensuring that the data type to be used in case of performing the model task determined by each of the plurality of devices is the same and unified, and ensuring an accuracy of subsequently performing the model task.

At step 403, the data type to be used in case of performing the model task is determined based on the indication information.

The method of the embodiment corresponding to FIG. 4 (i.e., step 401-step 403) may be applied to a scenario where “the plurality of devices participating in performing the model task include the network device (i.e., the plurality of devices participating in performing the model task include both the terminal device and the network device)”.

To sum up, in the method for determining the data type provided by an embodiment of the present disclosure, the terminal device determines the data type to be used in case of performing the model task, in which, the data type determined by the terminal device is the same as the data types determined by the other device among the plurality of devices excluding the terminal device. That is, in the present disclosure, the data type to be used in case of performing the model task determined by each of the plurality of devices that jointly participate in performing the model task is the same, so that the plurality of devices may perform the model task based on the same data type. There is no need to type-convert usage data of the plurality of devices during performing the model task, thus ensuring a performing accuracy of the model task, further ensuring an accuracy of an AI model obtained based on the model task, and improving user experience of the AI model.

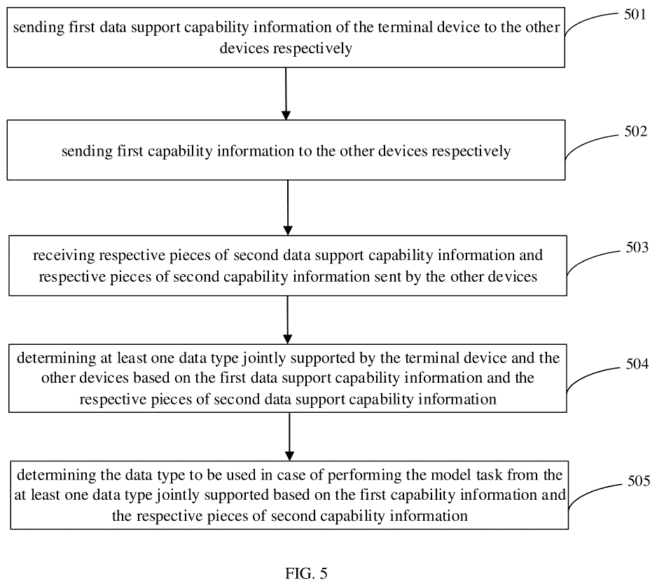

FIG. 5 is a flowchart of a method for determining a data type provided by an embodiment of the disclosure. A plurality of devices jointly participate in performing a model task. The method is performed by a terminal device among the plurality of devices. As illustrated in FIG. 5, in response to the plurality of devices not including a network device, the method may include following steps.

At step 501, first data support capability information of the terminal device is sent to the other devices respectively.

Other relevant introductions about step 501 may refer to description of the above embodiment.

At step 502, first capability information is sent to the other devices respectively.

In an embodiment of the present disclosure, the first capability information may indicate at least one of:
a storage capacity of the terminal device; or
a power consumption capability of the terminal device.

In an embodiment of the present disclosure, the first capability information may be sent by the terminal device to the other devices via a D2D manner.

In an embodiment of the present disclosure, the storage capability of the terminal device may be a current storage capability of the terminal device, and the power consumption capability of the terminal device may be a current power consumption capability of the terminal device.

At step 503, respective pieces of second data support capability information and respective pieces of second capability information sent by the other devices are received.

In an embodiment of the present disclosure, the respective pieces of second data support capability information indicate data types supported by the other devices, and the respective pieces of second capability information indicate at least one of:
storage capacities of the other devices; or
power consumption capabilities of the other devices.

The storage capacity of other device may be a current storage capacity of the other device, and the power consumption capacity of other device may be a current power consumption capacity of other device.

As can be seen from steps 501-503, in an embodiment of the present disclosure, in a case that the plurality of devices participating in performing the model task do not include the network device, the plurality of devices may interact with each other in terms of at least one of their data support capabilities, storage capabilities, or power consumption capabilities, rendering that each device participating in the model task knows the data types supported by the other devices in addition to itself and the storage capabilities and/or the power consumption capabilities of the other devices. Subsequently, each device may determine the final data type to be used in case of performing the model task based on the data types supported by the other devices and the storage capabilities and/or the power consumption capabilities of the other devices together with the data type supported by the device itself and the storage capability and/or the power consumption capability of the device itself (i.e., subsequent steps 504-505).

At step 504, at least one data type jointly supported by the terminal device and the other devices is determined based on the first data support capability information and the respective pieces of second data support capability information.

A detailed introduction to step 504 may refer to description of step 303 above, and an embodiment of the present disclosure will not be repeated herein.

At step 505, the data type to be used in case of performing the model task is determined from the at least one data type jointly supported based on the first capability information and the respective pieces of second capability information In an embodiment of the present disclosure, the method of determining the data type to be used in case of performing the model task from the at least one data type jointly supported based on the first capability information and the respective pieces of second capability information may include: selecting a third data type with an accuracy matching a capability indicated by the first capability information and/or the second capability information from the at least one data type jointly supported; determining the third data type as the data type to be used in case of performing the model task.

Specifically, in an embodiment of the present disclosure, the terminal device determines the third data type based on comprehensive consideration of the storage capabilities and/or the power consumption capabilities of the plurality of devices participating in performing the model task. The accuracy of the third data type is matched with a comprehensive storage capability and/or a comprehensive power consumption capability of the plurality of devices. For example, in a case that the comprehensive storage capacity and/or the comprehensive power consumption capacity of the plurality of devices is stronger, it means that the plurality of devices participating in performing the model task can support a data type with a higher accuracy and more bits. At this case, the selected third data type may have a higher accuracy and more bits. In a case that the comprehensive storage capacity and/or the comprehensive power consumption capability of the plurality of devices are weaker, it means that the plurality of devices participating in performing the model task may support a data type with a lower accuracy and fewer bits. At this case, the selected third data type may have a lower accuracy and fewer bits.

For example, in an embodiment of the present disclosure, assumed that the data types jointly supported include integer and single float. At this case, in response to a relative stronger storage capability of the first capability information and/or the second capability information, double float may be selected as the data type to be used in case of performing the model task; in response to a relative weaker storage capability of the first capability information and/or the second capability information, the integer may be selected as the data type to be used in case of performing the model task.

In addition, it is noted that in an embodiment of the present disclosure, in a case that each terminal device among the plurality of devices independently determines the data type to be used from the data types jointly supported by performing the above steps 504-505, each terminal device may adopt the same method (or the same rule) to determine the data type to be used from the data types jointly supported. For example, each terminal device may determine the data type to be used from the data types jointly supported by means of the method (or rule) of “the storage capability and/or the power consumption capability present a positive correlation with the accuracy of the determined data type to be used” or, the method (or rule) of “the storage capacity and/or the power consumption capacity present a negative correlation with the accuracy of the determined data type to be used”. The data type used is determined in the data type to ensure that the data type determined by each terminal device is the same, ensuring the accuracy of executing the model task.

The method of the embodiment corresponding to FIG. 5 (i.e., step 501-step 505) may be applied to a scenario where “the plurality of devices participating in performing the model task do not include the network device (i.e., the plurality of devices participating in performing the model task are all terminal devices)”.

A detailed introduction of other contents in embodiments of the present disclosure may refer to relevant introductions in the above embodiments.

To sum up, in the method for determining the data type provided by an embodiment of the present disclosure, the terminal device determines the data type to be used in case of performing the model task, in which, the data type determined by the terminal device is the same as the data types determined by the other device among the plurality of devices excluding the terminal device. That is, in the present disclosure, the data type to be used in case of performing the model task determined by each of the plurality of devices that jointly participate in performing the model task is the same, so that the plurality of devices may perform the model task based on the same data type. There is no need to type-convert usage data of the plurality of devices during performing the model task, thus ensuring a performing accuracy of the model task, further ensuring an accuracy of an AI model obtained based on the model task, and improving user experience of the AI model.

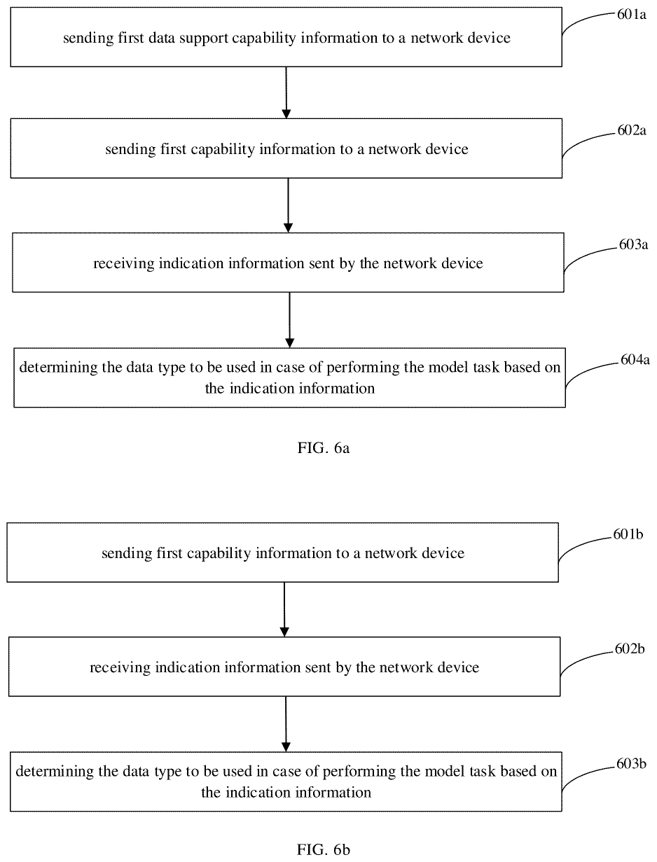

FIG. 6a is a flowchart of a method for determining a data type provided by an embodiment of the disclosure. A plurality of devices jointly participate in performing a model task. The method is performed by a terminal device among the plurality of devices. As illustrated in FIG. 6a, in response to the plurality of devices including a network device, the method may include following steps.

At step 601a, first data support capability information is sent to the network device.

A detailed introduction to step 601a may refer to relevant introductions in the above embodiments, and embodiments of the present disclosure will not be repeated herein.

At step 602a, first capability information is sent to the network device.

In an embodiment of the present disclosure, the first capability information indicates at least one of:
a storage capacity of the terminal device; or
a power consumption capability of the terminal device.

In an embodiment of the present disclosure, in a case that the plurality of devices participating in performing the model task include the network device and the terminal device, each terminal device in the plurality of devices needs to send the first capability information to the network device.

At step 603a, indication information sent by the network device is received.

In an embodiment of the present disclosure, the indication information indicates the data type to be used in case of performing the model task. The data type indicated by the indication information is specifically determined by the network device based on the first data support capability information and the first capability information sent by each terminal device.

In an embodiment of the present disclosure, the indication information received by each terminal device is the same, thus ensuring that the data type to be used in case of performing the model task determined by each of the plurality of devices is the same and unified, and ensuring an accuracy of subsequently performing the model task.

At step 604a, the data type to be used in case of performing the model task is determined based on the indication information.

The method of the embodiment corresponding to FIG. 6a (i.e., step 601a-step 604a) may be applied to a scenario where “the plurality of devices participating in performing the model task include the network device (i.e., the plurality of devices participating in performing the model task include both the terminal device and the network device)”.

A detailed introduction to other contents of the embodiments may refer to the relevant introductions in the above embodiments, and the embodiments of the present disclosure will not be repeated herein.

To sum up, in the method for determining the data type provided by an embodiment of the present disclosure, the terminal device determines the data type to be used in case of performing the model task, in which, the data type determined by the terminal device is the same as the data types determined by the other device among the plurality of devices excluding the terminal device. That is, in the present disclosure, the data type to be used in case of performing the model task determined by each of the plurality of devices that jointly participate in performing the model task is the same, so that the plurality of devices may perform the model task based on the same data type. There is no need to type-convert usage data of the plurality of devices during performing the model task, thus ensuring a performing accuracy of the model task, further ensuring an accuracy of an AI model obtained based on the model task, and improving user experience of the AI model.

FIG. 6b is a flowchart of a method for determining a data type provided by an embodiment of the disclosure. A plurality of devices jointly participate in performing a model task. The method is performed by a terminal device among the plurality of devices. As illustrated in FIG. 6b, in response to the plurality of devices including a network device, the method may include following steps.

At step 601b, first capability information is sent to the network device.

A detailed introduction to the first capability information may refer to the relevant introduction in the above embodiments, and the embodiments of the present disclosure will not be repeated herein.

At step 602b, indication information sent by the network device is received.

In an embodiment of the present disclosure, the indication information indicates the data type to be used in case of performing the model task. The data type indicated by the indication information is specifically determined by the network device based on the first capability information sent by each terminal device and the data type supported by each terminal device. The data type supported by each terminal device may be obtained by the network device from a core network.

In an embodiment of the present disclosure, the indication information received by each terminal device is the same, thus ensuring that the data type to be used in case of performing the model task determined by each of the plurality of devices is the same and unified, and ensuring an accuracy of subsequently performing the model task.

At step 603b, the data type to be used in case of performing the model task is determined based on the indication information.

The method of the embodiment corresponding to FIG. 6b (i.e., step 601b-step 603b) may be applied to a scenario where “the plurality of devices participating in performing the model task include the network device (i.e., the plurality of devices participating in performing the model task include both the terminal device and the network device)”.

A detailed introduction to other contents of the embodiments may refer to the relevant introductions in the above embodiments, and the embodiments of the present disclosure will not be repeated herein.

To sum up, in the method for determining the data type provided by an embodiment of the present disclosure, the terminal device determines the data type to be used in case of performing the model task, in which, the data type determined by the terminal device is the same as the data types determined by the other device among the plurality of devices excluding the terminal device. That is, in the present disclosure, the data type to be used in case of performing the model task determined by each of the plurality of devices that jointly participate in performing the model task is the same, so that the plurality of devices may perform the model task based on the same data type. There is no need to type-convert usage data of the plurality of devices during performing the model task, thus ensuring a performing accuracy of the model task, further ensuring an accuracy of an AI model obtained based on the model task, and improving user experience of the AI model.

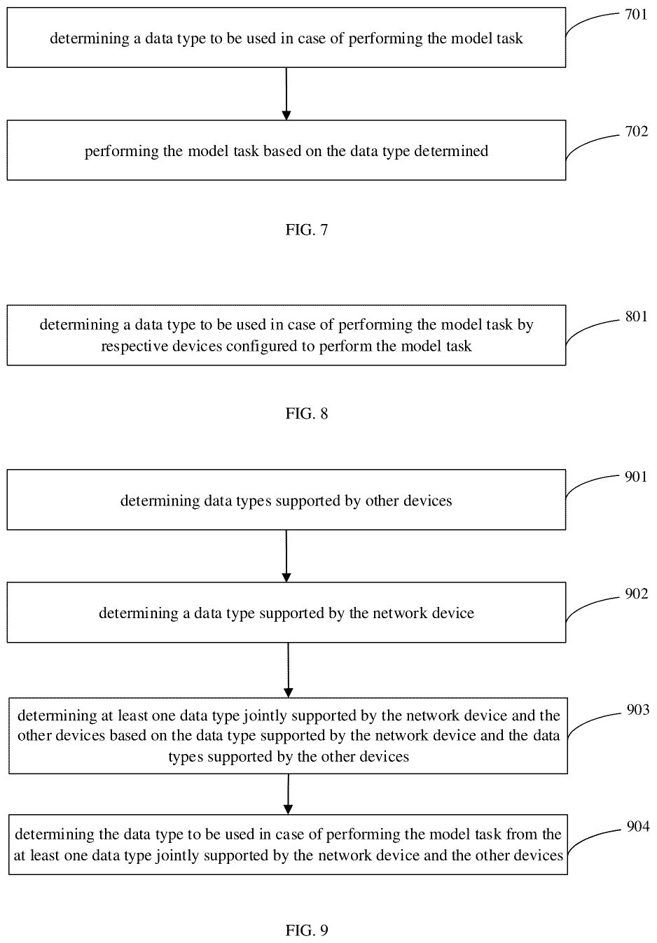

FIG. 7 is a flowchart of a method for determining a data type provided by an embodiment of the disclosure. A plurality of devices jointly participate in performing a model task. The method is performed by a terminal device among the plurality of devices. As illustrated in FIG. 7, the method may include following steps.

At step 701, a data type to be used in case of performing the model task is determined.

At step 702, the model task is performed based on the data type determined.

In an embodiment of the present disclosure, since the data type determined by the terminal device is the same as the data types determined by the other devices, the model task may be performed based on the same unified data type in a case that the plurality of devices jointly participate in performing the model task.

A detailed introduction to other contents in this embodiment may refer to the relevant introduction in the above embodiment, and the embodiment of the present disclosure will not be repeated herein.

To sum up, in the method for determining the data type provided by an embodiment of the present disclosure, the terminal device determines the data type to be used in case of performing the model task, in which, the data type determined by the terminal device is the same as the data types determined by the other device among the plurality of devices excluding the terminal device. That is, in the present disclosure, the data type to be used in case of performing the model task determined by each of the plurality of devices that jointly participate in performing the model task is the same, so that the plurality of devices may perform the model task based on the same data type. There is no need to type-convert usage data of the plurality of devices during performing the model task, thus ensuring a performing accuracy of the model task, further ensuring an accuracy of an AI model obtained based on the model task, and improving user experience of the AI model.

FIG. 8 is a flowchart of a method for determining a data type provided by an embodiment of the disclosure. The method is performed by a network device. The network device and other devices jointly participate in performing a model task. As illustrated in FIG. 8, the method may include a following step.

At step 801, a data type to be used in case of performing the model task by respective devices configured to perform the model task is determined.

In an embodiment of the present disclosure, the above model task may include a model training task and/or a model reasoning task. “A plurality of devices jointly participate in performing the model task” can be understood as: the plurality of devices jointly perform one model task (such as the model training task or the model reasoning task). Each different device is configured to be responsible for at least a part of the model training task. The model task is implemented through interaction between respective devices.

The above data type may include at least one of an integer (int), a single float (i.e., a 16-bit float), and a double float (i.e., a 32-bit float).

It is noted that in an embodiment of the present disclosure, the data type to be used in case of performing the model task determined by the network device for each device is same, which may ensure that the plurality of devices adopt the same data type to perform the model task, and may further ensure unification of data types of performing the model task by the plurality of devices, and ensure an accuracy of performing the model task.

The method of the embodiment corresponding to FIG. 8 (i.e., step 801) may be applied to a scenario where “the plurality of devices participating in performing the model task include the network device (i.e., the plurality of devices participating in performing the model task include both the terminal device and the network device)”.

The specific execution method of step 801 will be introduced in detail in subsequent embodiments.

A detailed introduction to other contents in this embodiment may refer to the relevant introduction in the above-mentioned embodiments, and the embodiments of the present disclosure will not be repeated herein.

To sum up, in the method for determining the data type provided by an embodiment of the present disclosure, the terminal device determines the data type to be used in case of performing the model task, in which, the data type determined by the terminal device is the same as the data types determined by the other device among the plurality of devices excluding the terminal device. That is, in the present disclosure, the data type to be used in case of performing the model task determined by each of the plurality of devices that jointly participate in performing the model task is the same, so that the plurality of devices may perform the model task based on the same data type. There is no need to type-convert usage data of the plurality of devices during performing the model task, thus ensuring a performing accuracy of the model task, further ensuring an accuracy of an AI model obtained based on the model task, and improving user experience of the AI model.

FIG. 9 is a flowchart of a method for determining a data type provided by an embodiment of the disclosure. The method is performed by a network device. The network device and other devices jointly participate in performing a model task. As illustrated in FIG. 9, the method may include following steps.

At step 901, data types supported by other devices are determined.

In an embodiment of the present disclosure, determining the data types supported by the other devices may include any one of:

receiving respective pieces of data support capability information sent by the other devices, in which, the respective pieces of data support capability information indicate data types supported by the other devices; or determining the data types supported by the other devices from a core network device, in which, the core network device may store their own supported data types pre-reported by respective devices, and the data types supported by respective devices are specifically reported by the device to the core network device when the device accesses the core network device.

At step 902, a data type supported by the network device is determined.

At step 903, at least one data type jointly supported by the network device and the other devices are determined based on the data type supported by the network device and the data types supported by the other devices.

A detailed introduction to step 903 may refer to the relevant introduction in the above embodiments, and the embodiments of this disclosure will not be repeated herein.

At step 904, the data type to be used in case of performing the model task is determined from the at least one data type jointly supported by the network device and the other devices.

In an embodiment of the present disclosure, determining the data type to be used in case of performing the model task from the at least one data type jointly supported by the network device and the other devices may include at least one of:
determining a first data type with a maximum accuracy among the at least one data type jointly supported as the data type to be used in case of performing the model task;
determining a second data type with less accurate than the first data type among the at least one data type jointly supported as the data type to be used in case of performing the model task;
determining the data type to be used in case of performing the model task from the at least one data type jointly supported based on a desired resource overhead of the model task; or
determining the data type to be used in case of performing the model task from the at least one data type jointly supported based on a service demand of the model task.

A detailed introduction to step 904 may refer to the above introduction to step 304, and the embodiment of the present disclosure will not be repeated herein.

A detailed introduction to other contents in this embodiment may refer to the relevant introduction in the above embodiment, and the embodiments of the present disclosure will not be repeated herein.

To sum up, in the method for determining the data type provided by an embodiment of the present disclosure, the terminal device determines the data type to be used in case of performing the model task, in which, the data type determined by the terminal device is the same as the data types determined by the other device among the plurality of devices excluding the terminal device. That is, in the present disclosure, the data type to be used in case of performing the model task determined by each of the plurality of devices that jointly participate in performing the model task is the same, so that the plurality of devices may perform the model task based on the same data type. There is no need to type-convert usage data of the plurality of devices during performing the model task, thus ensuring a performing accuracy of the model task, further ensuring an accuracy of an AI model obtained based on the model task, and improving user experience of the AI model.

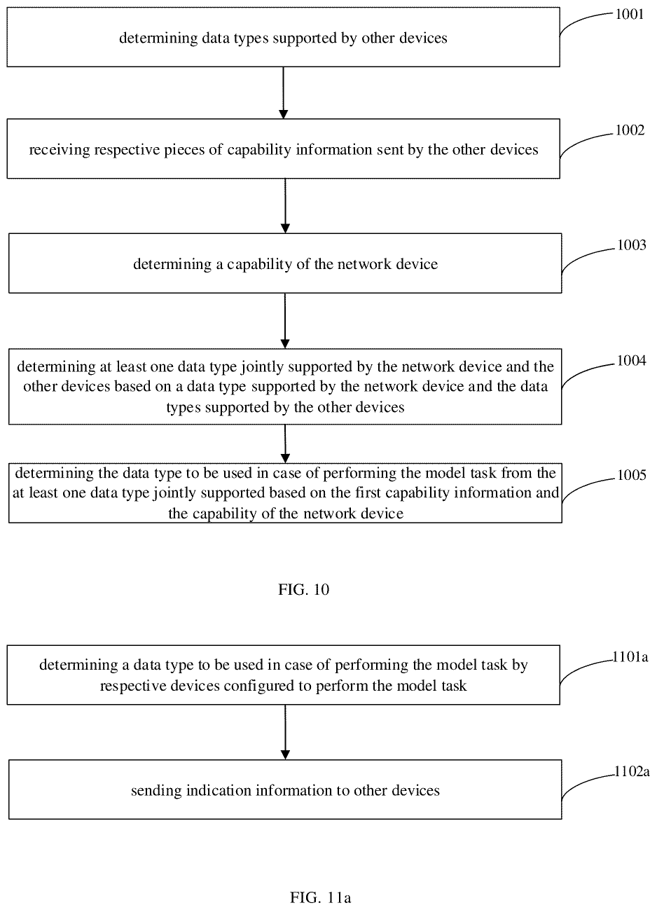

FIG. 10 is a flowchart of a method for determining a data type provided by an embodiment of the disclosure. The method is performed by a network device. The network device and other devices jointly participate in performing a model task. As illustrated in FIG. 10, the method may include following steps.

At step 1001, data types supported by other devices are determined.

A detailed introduction to step 1001 may refer to the description of the above embodiments, and the embodiments of the present disclosure will not be repeated herein.

At step 1002, respective pieces of capability information sent by the other devices are received.

In an embodiment of the present disclosure, the capability information may include at least one of:
storage capacities of the other devices; or
power consumption capabilities of the other devices.

A detailed introduction to the capability information may refer to the relevant introduction in the above embodiments, and the embodiments of the present disclosure will not be repeated herein.

At step 1003, a capability of the network device is determined.

In an embodiment of the present disclosure, the capability may include a storage capability and/or a power consumption capability.

A detailed introduction to the storage capability and the power consumption capability may refer to the relevant introduction in the above embodiments, and the embodiments of the present disclosure will not be repeated herein.

At step 1004, at least one data type jointly supported by the network device and the other devices is determined based on a data type supported by the network device and the data types supported by the other devices.

A detailed introduction to step 1004 may refer to the relevant introduction in the above embodiments, and the embodiments of this disclosure will not be repeated herein.

At step 1005, the data type to be used in case of performing the model task is determined from the at least one data type jointly supported based on the first capability information and the capability of the network device In an embodiment of the present disclosure, determining the data type to be used in case of performing the model task from the at least one data type jointly supported based on the first capability information and the capability of the network device may include: selecting a third data type with an accuracy matching a capability indicated by the capability information and/or the capability of the network device from the at least one data type jointly supported; and determining the third data type as the data type to be used in case of performing the model task.

A detailed introduction to step 1005 may refer to the relevant introduction in the above embodiments, and the embodiments of this disclosure will not be repeated herein.

A detailed introduction to other contents in this embodiment may refer to the relevant introduction in the above embodiment, and the embodiments of the present disclosure will not be repeated herein.

To sum up, in the method for determining the data type provided by an embodiment of the present disclosure, the terminal device determines the data type to be used in case of performing the model task, in which, the data type determined by the terminal device is the same as the data types determined by the other device among the plurality of devices excluding the terminal device. That is, in the present disclosure, the data type to be used in case of performing the model task determined by each of the plurality of devices that jointly participate in performing the model task is the same, so that the plurality of devices may perform the model task based on the same data type. There is no need to type-convert usage data of the plurality of devices during performing the model task, thus ensuring a performing accuracy of the model task, further ensuring an accuracy of an AI model obtained based on the model task, and improving user experience of the AI model.

FIG. 11a is a flowchart of a method for determining a data type provided by an embodiment of the disclosure. The method is performed by a network device. The network device and other devices jointly participate in performing a model task. As illustrated in FIG. 11a, the method may include following steps.

At step 1101a, a data type to be used in case of performing the model task by respective devices configured to perform the model task is determined.

A detailed introduction to step 1101a may refer to the relevant introduction in the above embodiments, and the embodiments of this disclosure will not be repeated herein.

At step 1102a, indication information is sent to other devices.

In an embodiment of the present disclosure, the indication information indicates the data type to be used in case of performing the model task.

In an embodiment of the present disclosure, the network device will send the same indication information to each of the other devices, so that each other device may determine the same data type based on the same indication information to perform the model task, thus ensuring ensure unification of data types of performing the model task by the respective other devices, and ensure an accuracy of performing the model task.

It is noted that in a case that the plurality of devices participating in performing the model task include the network device, the network device may allocate a specific model task to the respective other devices. In an embodiment of the present disclosure, the network device may determine the data type to be used in case of performing the model task before allocating the model task to the respective other devices, and then may also allocate the model task to the respective other devices while sending the indication information to the respective other devices to indicate the data type to be used in case of performing the model task.

To sum up, in the method for determining the data type provided by an embodiment of the present disclosure, the terminal device determines the data type to be used in case of performing the model task, in which, the data type determined by the terminal device is the same as the data types determined by the other device among the plurality of devices excluding the terminal device. That is, in the present disclosure, the data type to be used in case of performing the model task determined by each of the plurality of devices that jointly participate in performing the model task is the same, so that the plurality of devices may perform the model task based on the same data type. There is no need to type-convert usage data of the plurality of devices during performing the model task, thus ensuring a performing accuracy of the model task, further ensuring an accuracy of an AI model obtained based on the model task, and improving user experience of the AI model.

FIG. 11b is a flowchart of a method for determining a data type provided by an embodiment of the disclosure. The method is performed by a network device. The network device and other devices jointly participate in performing a model task. As illustrated in FIG. 11b, the method may include following steps.

At step 1101b, a data type to be used in case of performing the model task by respective devices configured to perform the model task is determined.

At step 1102b, the model task is performed based on the data type determined.

Detailed introductions to step 1101b and step 1102b may refer to the relevant introduction in the above embodiments, and the embodiments of this disclosure will not be repeated herein.

To sum up, in the method for determining the data type provided by an embodiment of the present disclosure, the terminal device determines the data type to be used in case of performing the model task, in which, the data type determined by the terminal device is the same as the data types determined by the other device among the plurality of devices excluding the terminal device. That is, in the present disclosure, the data type to be used in case of performing the model task determined by each of the plurality of devices that jointly participate in performing the model task is the same, so that the plurality of devices may perform the model task based on the same data type. There is no need to type-convert usage data of the plurality of devices during performing the model task, thus ensuring a performing accuracy of the model task, further ensuring an accuracy of an AI model obtained based on the model task, and improving user experience of the AI model.

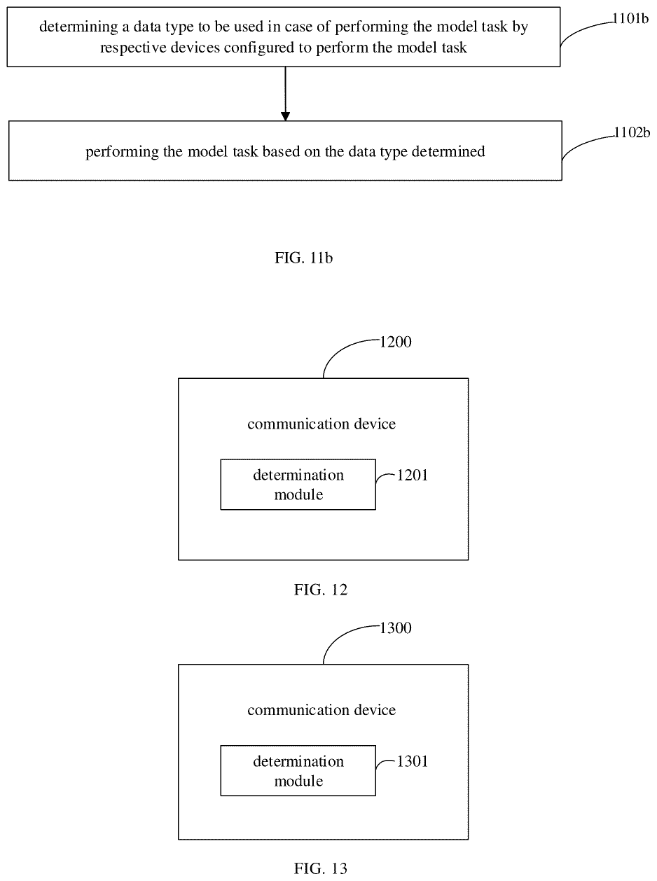

FIG. 12 is a structural diagram of a communication device provided by an embodiment of the disclosure. As illustrated in FIG. 12, the device may include a determination module 1201.

The determination module 1201 is configured to determine a data type to be used in case of performing the model task, in which, a data type determined by the terminal device is the same as data types determined by other device among the plurality of devices excluding the terminal device.

To sum up, in the communication device provided by an embodiment of the present disclosure, the terminal device determines the data type to be used in case of performing the model task, in which, the data type determined by the terminal device is the same as the data types determined by the other device among the plurality of devices excluding the terminal device. That is, in the present disclosure, the data type to be used in case of performing the model task determined by each of the plurality of devices that jointly participate in performing the model task is the same, so that the plurality of devices may perform the model task based on the same data type. There is no need to type-convert usage data of the plurality of devices during performing the model task, thus ensuring a performing accuracy of the model task, further ensuring an accuracy of an AI model obtained based on the model task, and improving user experience of the AI model.

Optionally, in an embodiment of the present disclosure, the above device is further configured to:
send first data support capability information to the other devices respectively, in which, the first data support capability information indicates a data type supported by the terminal device.

Optionally, in an embodiment of the present disclosure, the above device is further configured to:
receive respective pieces of second data support capability information sent by the other devices, wherein the respective pieces of second data support capability information indicate data types supported by the other devices.

In response to the plurality of devices not including a network device, the above determination module 1201 is further configured to:
determine at least one data type jointly supported by the terminal device and the other devices based on the first data support capability information and the respective pieces of second data support capability information; and
determine the data type to be used in case of performing the model task from the at least one data type jointly supported by the terminal device and the other devices, in which, the terminal device and the other devices adopt the same method to determine the data type to be used in case of performing the model task from the at least one data type jointly supported by the terminal device and the other devices.

Optionally, in an embodiment of the present disclosure, the above determination module 1201 is further configured to:
determine a first data type with a maximum accuracy among the at least one data type jointly supported as the data type to be used in case of performing the model task;
determine a second data type with less accurate than the first data type among the at least one data type jointly supported as the data type to be used in case of performing the model task;
determine the data type to be used in case of performing the model task from the at least one data type jointly supported based on a desired resource overhead of the model task; or
determine the data type to be used in case of performing the model task from the at least one data type jointly supported based on a service demand of the model task.

Optionally, in an embodiment of the present disclosure, the above device is further configured to:
send first capability information to the other devices respectively, in which, the first capability information indicates at least one of:
a storage capacity of the terminal device; or
a power consumption capability of the terminal device.

Optionally, in an embodiment of the present disclosure, the above device is further configured to:
receive respective pieces of second data support capability information and respective pieces of second capability information sent by the other devices, in which, the respective pieces of second data support capability information indicate data types supported by the other devices, and the respective pieces of second capability information indicate at least one of:
storage capacities of the other devices; or
power consumption capabilities of the other devices.

Optionally, in an embodiment of the present disclosure, the above device is further configured to:
determine at least one data type jointly supported by the terminal device and the other devices based on the first data support capability information and the respective pieces of second data support capability information; and
determine the data type to be used in case of performing the model task from the at least one data type jointly supported based on the first capability information and the respective pieces of second capability information.

Optionally, in an embodiment of the present disclosure, the above determination module 1201 is further configured to:
select a third data type with an accuracy matching a capability indicated by the first capability information and/or the second capability information from the at least one data type jointly supported, in which an accuracy of the third data type presents a positive correlation with the storage capacity and the power consumption capacity;
determine the third data type as the data type to be used in case of performing the model task.

Optionally, in an embodiment of the present disclosure, the above device is further configured to:
send first data support capability information and/or first capability information to a network device.

Optionally, in an embodiment of the present disclosure, the above determination module 1201 is further configured to:
receive indication information sent by the network device, in which, the indication information indicates the data type to be used in case of performing the model task; and
determine the data type to be used in case of performing the model task based on the indication information.

Optionally, in an embodiment of the present disclosure, the above device is further configured to: perform the model task based on the data type determined.

Optionally, in an embodiment of the present disclosure, the model task includes a model training task and/or a model reasoning task.

FIG. 13 is a structural diagram of a communication device provided by an embodiment of the disclosure. As illustrated in FIG. 13, the device may include a determination module 1301.

The determination module 1301 is configured to determine a data type to be used in case of performing the model task by respective devices configured to perform the model task, in which, the data type to be used in case of performing the model task determined by the network device for each device is same.

To sum up, in the communication device provided by an embodiment of the present disclosure, the terminal device determines the data type to be used in case of performing the model task, in which, the data type determined by the terminal device is the same as the data types determined by the other device among the plurality of devices excluding the terminal device. That is, in the present disclosure, the data type to be used in case of performing the model task determined by each of the plurality of devices that jointly participate in performing the model task is the same, so that the plurality of devices may perform the model task based on the same data type. There is no need to type-convert usage data of the plurality of devices during performing the model task, thus ensuring a performing accuracy of the model task, further ensuring an accuracy of an AI model obtained based on the model task, and improving user experience of the AI model.

Optionally, in an embodiment of the present disclosure, the above determination module 1301 is further configured to:
determine data types supported by other devices among the plurality of devices excluding the network device.

Optionally, in an embodiment of the present disclosure, the above determination module 1301 is further configured to:
receive respective pieces of data support capability information sent by the other devices, in which, the respective pieces of data support capability information indicate data types supported by the other devices; or
determine the data types supported by the other devices from a core network device.

Optionally, in an embodiment of the present disclosure, the above determination module 1301 is further configured to:
determine a data type supported by the network device;
determine at least one data type jointly supported by the network device and the other devices based on the data type supported by the network device and the data types supported by the other devices;
determine the data type to be used in case of performing the model task from the at least one data type jointly supported by the network device and the other devices.

Optionally, in an embodiment of the present disclosure, the above determination module 1301 is further configured to:
determine a first data type with a maximum accuracy among the at least one data type jointly supported as the data type to be used in case of performing the model task;
determine a second data type with less accurate than the first data type among the at least one data type jointly supported as the data type to be used in case of performing the model task;
determine the data type to be used in case of performing the model task from the at least one data type jointly supported based on a desired resource overhead of the model task; or
determine the data type to be used in case of performing the model task from the at least one data type jointly supported based on a service demand of the model task.

Optionally, in an embodiment of the present disclosure, the above device is further configured to:
receive respective pieces of capability information sent by the other devices, in which, the capability information includes at least one of:
storage capacities of the other devices; or
power consumption capabilities of the other devices.

Optionally, in an embodiment of the present disclosure, the above determination module 1301 is further configured to:
determine a capability of the network device, wherein the capability of the network device comprises a storage capability and/or a power consumption capability;
determine at least one data type jointly supported by the network device and the other devices based on a data type supported by the network device and the data types supported by the other devices; and
determine the data type to be used in case of performing the model task from the at least one data type jointly supported based on the respective pieces of capability information received and the capability of the network device.

Optionally, in an embodiment of the present disclosure, the above determination module 1301 is further configured to:
select a third data type with an accuracy matching a capability indicated by the capability information and/or the capability of the network device from the at least one data type jointly supported, in which, an accuracy of the third data type presents a positive correlation with the storage capacity and the power consumption capacity; and
determine the third data type as the data type to be used in case of performing the model task.

Optionally, in an embodiment of the present disclosure, the above device is further configured to:
send indication information to other devices among the plurality of devices excluding the network device, in which, the indication information indicates the data type to be used in case of performing the model task.

Optionally, in an embodiment of the present disclosure, the above device is further configured to:
perform the model task based on the data type determined.

Optionally, in an embodiment of the present disclosure, the model task includes a model training task and/or a model reasoning task.

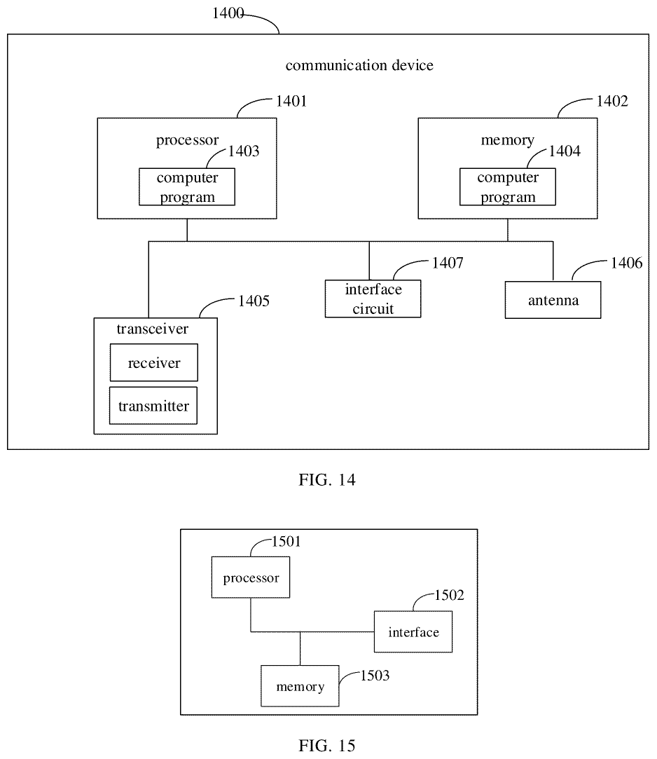

FIG. 14 is a structural diagram of a communication device 1400 provided by an embodiment of the disclosure. The communication device 1400 may be a network device or a terminal device, or may be a chip, a chip system or a processor that supports the network device to realize the above-described methods, or may be a chip, a chip system or a processor that supports the terminal device to realize the above-described methods. The communication device may be used to realize the methods described in the above method embodiments with reference to the description of the above-described method embodiments.

The communication device 1400 may include one or more processors 1401. The processor 1401 may be a general purpose processor or a dedicated processor, such as, a baseband processor and a central processor. The baseband processor is used for processing communication protocols and communication data. The central processor is used for controlling the communication device (e.g., a base station, a baseband chip, a terminal device, a terminal device chip, a DU, or a CU), executing computer programs, and processing data of the computer programs.

Optionally, the communication device 1400 may include one or more memories 1402 on which computer programs 1404 may be stored. The processor 1401 executes the computer programs 1404 to cause the communication device 1400 to perform the methods described in the above method embodiments. Optionally, the memory 1402 may also store data. The communication device 1400 and the memory 1402 may be provided separately or may be integrated together.

Optionally, the communication device 1400 may also include a transceiver 1405 and an antenna 1406. The transceiver 1405 may be referred to as a transceiver unit, a transceiver machine, or a transceiver circuit, for realizing a transceiver function. The transceiver 1405 may include a receiver and a transmitter. The receiver may be referred to as a receiving machine or a receiving circuit, for realizing the receiving function. The transmitter may be referred to as a transmitter machine or a transmitting circuit, for realizing the transmitting function.

Optionally, the communication device 1400 may also include one or more interface circuits 1407. The interface circuits 1407 are used to receive code instructions and transmit them to the processor 1401. The processor 1401 runs the code instructions to cause the communication device 1400 to perform the method described in the method embodiments.

In a case where the communication device 1400 is a base station, the transceiver 1405 is used to perform steps 301 to 302 in FIG. 3; steps 401 to 402 in FIG. 4; steps 501 to 503 in FIG. 5; steps 601a to 603a in FIG. 6a; step 601b to step 602b in FIG. 6b. The processor 1401 is used to perform step 201 in FIG. 2; step 303 and step 304 in FIG. 3; step 403 in FIG. 4; step 504 and step 505 in FIG. 5; step 604a in FIG. 6a; step 603b in FIG. 6b; step 701 and step 702 in FIG. 7.

In a case where the communication device 1400 is a network device, the transceiver 1405 is used to perform step 1102a in FIG. 11a. The processor 1401 is used to perform step 801 in FIG. 8; steps 901 to 904 in FIG. 9; steps 1001 to 1005 in FIG. 10; step 1101a in FIG. 11a; and steps 1101b and 1102b in FIG. 11b.

In an implementation, the processor 1401 may include a transceiver for implementing the receiving and sending functions. The transceiver may be, for example, a transceiver circuit, an interface, or an interface circuit. The transceiver circuit, the interface, or the interface circuit for implementing the receiving and sending functions may be separated or may be integrated together. The transceiver circuit, the interface, or the interface circuit described above may be used for reading and writing code/data, or may be used for signal transmission or delivery.

In an implementation, the processor 1401 may store a computer program 1403. The processor 1401 runs the computer program 1403 to cause the communication device 1400 to perform the methods described in the method embodiments above. The computer program 1403 may be solidified in the processor 1401, and in such case the processor 1401 may be implemented by hardware.

In an implementation, the communication device 1400 may include circuits. The circuits may implement the sending, receiving or communicating function in the preceding method embodiments. The processor and the transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver are produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device in the description of the above embodiments may be a network device or a terminal device, but the scope of the communication device described in the disclosure is not limited thereto, and the structure of the communication device may not be limited by FIG. 14. The communication device may be a stand-alone device or may be part of a larger device. For example, the described communication device may be:
(1) a stand-alone integrated circuit (IC), a chip, a chip system or subsystem;
(2) a set of ICs including one or more ICs, optionally, the set of ICs may also include storage components for storing data and a computer program;
(3) an ASIC, such as a modem;
(4) a module that can be embedded within other devices;
(5) a receiver, a terminal device, a smart terminal device, a cellular phone, a wireless device, a handheld machine, a mobile unit, an in-vehicle device, a network device, a cloud device, an artificial intelligence device, and the like; and
(6) others.

For a case where the communication device is a chip or a chip system, reference may be made to a structural diagram of a chip as illustrated in FIG. 15. The chip illustrated in FIG. 15 includes a processor 1501 and an interface 1502. There may be may be one or more processors 1501, and a plurality of interfaces 1502.

Optionally, the chip further includes a memory 1503, the memory 1503 is configured to store necessary computer programs and data.

It is understood by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be understood as beyond the scope of protection of the embodiments of the disclosure.

The disclosure also provides a readable storage medium having instructions stored thereon. When the instructions are executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, the above embodiments may be implemented, in whole or in part, in the form of a computer program product. The computer program product includes one or more computer programs. When loading and executing the computer program on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., using coaxial cables, fiber optics, or digital subscriber lines (DSLs) or wireless manner (e.g., using infrared wave, wireless wave, or microwave). The computer-readable storage medium may be any usable medium to which the computer is capable to access or a data storage device such as a server integrated by one or more usable mediums and a data center. The usable medium may be a magnetic medium (e.g., a floppy disk, a hard disk, and a tape), an optical medium (e.g., a high-density digital video disc (DVD)), or a semiconductor medium (e.g., a solid state disk (SSD)).

Those skilled in the art understand that “first”, “second”, or other various numerical numbers involved in the disclosure are only described for the convenience of differentiation, and are not used to limit the scope of the embodiments of the disclosure, or used to indicate the order of precedence.

The term “at least one” in the disclosure may also be described as one or more, and the term “more” may be two, three, four, or more, which is not limited in the disclosure. In the embodiments of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

The correspondences shown in the tables in this disclosure may be configured or may be predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in this disclosure may not be configured. For another example, the above tables may be adjusted appropriately, such as splitting, combining, and the like. The names of the parameters shown in the titles of the above tables may be other names that can be understood by the communication device, and the values or representations of the parameters may be other values or representations that can be understood by the communication device. Each of the above tables may also be implemented with other data structures, such as, arrays, queues, containers, stacks, linear tables, pointers, chained lists, trees, graphs, structures, classes, heaps, and Hash tables.

The term “predefine” in this disclosure may be understood as define, predefine, store, pre-store, pre-negotiate, pre-configure, solidify, or pre-fire.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above can be referred to the corresponding processes in the preceding method embodiments, and will not be repeated herein.

The above are only specific implementations of the disclosure, but the scope of protection of the disclosure is not limited thereto. Those skilled in the art familiar to this technical field can easily think of changes or substitutions in the technical scope disclosed by the disclosure, which shall be covered by the scope of protection of the disclosure. Therefore, the scope of protection of the disclosure shall be governed by the scope of protection of the appended claims.

1. A method for determining a data type, performed by a terminal device among a plurality of devices which jointly participate in performing a model task, and comprisescomprising:
determining a data type to be used in case of performing the model task, wherein a data type determined by the terminal device is the same as data types determined by other device among the plurality of devices excluding the terminal device.

2. The method according to claim 1, further comprising:
sending first data support capability information to the other devices respectively, wherein the first data support capability information indicates a data type supported by the terminal device.

3. The method according to claim 2, further comprising:
receiving respective pieces of second data support capability information sent by the other devices, wherein the respective pieces of second data support capability information indicate data types supported by the other devices.

4. The method according to claim 3, wherein determining the data type to be used in case of performing the model task comprises:
determining at least one data type jointly supported by the terminal device and the other devices based on the first data support capability information and the respective pieces of second data support capability information; and
determining the data type to be used in case of performing the model task from the at least one data type jointly supported by the terminal device and the other devices.

5. The method according to claim 4, wherein determining the data type to be used in case of performing the model task from the at least one data type jointly supported by the terminal device and the other devices comprises at least one of:
determining a first data type with a maximum accuracy among the at least one data type jointly supported as the data type to be used in case of performing the model task;
determining a second data type with less accurate than the first data type among the at least one data type jointly supported as the data type to be used in case of performing the model task;
determining the data type to be used in case of performing the model task from the at least one data type jointly supported based on a desired resource overhead of the model task; or
determining the data type to be used in case of performing the model task from the at least one data type jointly supported based on a service demand of the model task.

6. The method according to claim 5, further comprising:
sending first capability information to the other devices respectively, wherein the first capability information indicates at least one of:
a storage capacity of the terminal device; or
a power consumption capability of the terminal device.

7. The method according to claim 6, further comprising:
receiving respective pieces of second data support capability information and respective pieces of second capability information sent by the other devices, wherein the respective pieces of second data support capability information indicate data types supported by the other devices, and the respective pieces of second capability information indicate at least one of:
storage capacities of the other devices; or
power consumption capabilities of the other devices;
wherein determining the data type to be used in case of performing the model task comprises:
determining at least one data type jointly supported by the terminal device and the other devices based on the first data support capability information and the respective pieces of second data support capability information; and
determining the data type to be used in case of performing the model task from the at least one data type jointly supported based on the first capability information and the respective pieces of second capability information.

8. (canceled)

9. The method according to claim 87, wherein determining the data type to be used in case of performing the model task from the at least one data type jointly supported based on the first capability information and the respective pieces of second capability information comprises:
selecting a third data type with an accuracy matching a capability indicated by the first capability information and/or the second capability information from the at least one data type jointly supported, wherein an accuracy of the third data type presents a positive correlation with the storage capacity and the power consumption capacity;
determining the third data type as the data type to be used in case of performing the model task.

10. The method according to claim 1, further comprising:
sending first data support capability information and/or first capability information to a network device.

11. The method according to claim 10, wherein determining the data type to be used in case of performing the model task comprises:
receiving indication information sent by the network device, wherein the indication information indicates the data type to be used in case of performing the model task; and
determining the data type to be used in case of performing the model task based on the indication information.

12. (canceled)

13. (canceled)

14. A method for determining a data type, performed by a network device among a plurality of devices which jointly participate in performing a model task, and comprisescomprising:
determining a data type to be used in case of performing the model task by respective devices configured to perform the model task, wherein the data type to be used in case of performing the model task determined by the network device for each device is same.

15. The method according to claim 14, further comprising:
determining data types supported by other devices among the plurality of devices excluding the network device.

16. The method according to claim 15, wherein determining the data types supported by the other devices among the plurality of devices excluding the network device comprises any one of:
receiving respective pieces of data support capability information sent by the other devices, wherein the respective pieces of data support capability information indicate data types supported by the other devices; or
determining the data types supported by the other devices from a core network device.

17. The method according to claim 16, wherein determining the data type to be used in case of performing the model task by respective devices configured to perform the model task comprises:
determining a data type supported by the network device;
determining at least one data type jointly supported by the network device and the other devices based on the data type supported by the network device and the data types supported by the other devices;
determining the data type to be used in case of performing the model task from the at least one data type jointly supported by the network device and the other devices.

18. The method according to claim 17, wherein determining the data type to be used in case of performing the model task from the at least one data type jointly supported by the network device and the other devices comprises at least one of:
determining a first data type with a maximum accuracy among the at least one data type jointly supported as the data type to be used in case of performing the model task;
determining a second data type with less accurate than the first data type among the at least one data type jointly supported as the data type to be used in case of performing the model task;
determining the data type to be used in case of performing the model task from the at least one data type jointly supported based on a desired resource overhead of the model task; or
determining the data type to be used in case of performing the model task from the at least one data type jointly supported based on a service demand of the model task.

19. The method according to claim 15, further comprising:
receiving respective pieces of capability information sent by the other devices, wherein the capability information comprises at least one of:
storage capacities of the other devices; or
power consumption capabilities of the other devices;
wherein determining the data type to be used in case of performing the model task by respective devices configured to perform the model task comprises:
determining a capability of the network device, wherein the capability of the network device comprises a storage capability and/or a power consumption capability;
determining at least one data type jointly supported by the network device and the other devices based on a data type supported by the network device and the data types supported by the other devices; and
determining the data type to be used in case of performing the model task from the at least one data type jointly supported based on the respective pieces of capability information received and the capability of the network device.

20. (canceled)

21. The method according to claim 19, wherein determining the data type to be used in case of performing the model task from the at least one data type jointly supported based on the respective pieces of capability information received and the capability of the network device comprises:
selecting a third data type with an accuracy matching a capability indicated by the capability information and/or the capability of the network device from the at least one data type jointly supported, wherein an accuracy of the third data type presents a positive correlation with the storage capacity and the power consumption capacity; and
determining the third data type as the data type to be used in case of performing the model task.

22. The method according to claim 14, further includes:
sending indication information to other devices among the plurality of devices excluding the network device, wherein the indication information indicates the data type to be used in case of performing the model task.

23. (canceled)

24. (canceled)

25. A terminal device, comprising a processor and a memory storing a computer program, wherein the processor is configured to:
determine a data type to be used in case of performing a model task, wherein a data type determined by the terminal device is the same as data types determined by other device among a plurality of devices excluding the terminal device.

26. A network device, comprising a processor and a memory storing a computer program, wherein the processor is configured to perform the method according to claim 14.

27.-29. (canceled)
